(19) United States
(12) Patent Application Publication
(10) Pub. No.: US 2026/0128391 A1
(43) Pub. Date: May 7, 2026

(54) Electrode Assembly and Secondary Battery Including the Same

(71) Applicant: LG ENERGY SOLUTION LTD., Seoul (KR)

(72) Inventor: Taemin Lee, Seoul (KR)

(73) Assignee: LG ENERGY SOLUTION LTD., Seoul (KR)

(21) Appl. No.: 19/120,380

(22) PCT Filed: Nov. 22, 2023
(86) PCT No.: PCT/KR2023/018888

§ 371 Date: Apr. 11, 2025

(30) Foreign Application Priority Data
Nov. 22, 2022 (KR) 10-2022-0157377

(51) Int. Cl. H01M 10/42; H01M 10/04; H01M 50/586; H01M 50/595

(52) U.S. Cl. CPC H01M 10/4235; H01M 10/0431; H01M 50/586; H01M 50/595

(57) ABSTRACT

An electrode assembly including electrodes, a separator interposed between the electrodes, and a tape attached to an electrode, wherein the electrodes and the separator are wound together to form a jelly roll structure, wherein the tape is attached to an end of the electrode, on a surface of the electrode, and one side of the tape has a non-linear pattern.

### CROSS REFERENCE TO RELATED APPLICATIONS

This application is a 371 National Stage entry of PCT/KR 2023/018888 filed on Nov. 22, 2023, which claims the benefit of Korean Patent Application No. 10-2022-0157377 filed on Nov. 22, 2022, in the Republic of Korea, the disclosures of which are incorporated by reference herein in their entirety.

### TECHNICAL FIELD

The present disclosure relates to an electrode assembly and a secondary battery including the same, and more particularly, to a jelly-roll shaped electrode assembly and a secondary battery including the same.

### BACKGROUND

In recent years, as the demand for portable electronic products such as notebook computers, video cameras, and mobile phones has been rapidly increasing, and electric vehicles, energy storage batteries, robots, satellites, etc. have been developed in earnest, a secondary battery used as a driving power source thereof has been actively researched and studied.

Such a secondary battery may include, for example, a nickel cadmium battery, a nickel hydrogen battery, a nickel zinc battery, a lithium secondary battery, and the like. Among them, the lithium secondary batteries are widely used in the field of high-tech electronic devices because they have advantages, for example, hardly exhibiting memory effects in comparison with nickel-based secondary batteries and thus being freely charged and discharged, and having very low self-discharge rate, high operating voltage and high energy density per unit weight.

Based on the shape of a battery case, a secondary battery may be classified into a cylindrical battery having an electrode assembly mounted in a cylindrical metal container, a prismatic battery having an electrode assembly mounted in a prismatic metal container, or a pouch-shaped battery having an electrode assembly mounted in a pouch-shaped case formed of an aluminum laminate sheet. The cylindrical battery has advantages in that the cylindrical battery has relatively large capacity and is structurally stable.

The electrode assembly mounted in the battery case serves as a power generating element, having a positive electrode/separator/negative electrode stack structure, which can be charged and discharged. The electrode assembly may be classified into a jelly roll type, a stacked type and a stacked/folded type. The jelly-roll type electrode assembly is configured to have a structure in which a long sheet type positive electrode and a long sheet type negative electrode, to which active materials are coated, are wound in a state in which a separator is disposed between the positive electrode and the negative electrode, the stacked type electrode assembly is configured to have a structure in which a plurality of positive electrodes having a predetermined size and a plurality of negative electrodes having a predetermined size are sequentially stacked in a state in which separators are disposed respectively between the positive electrodes and the negative electrodes, or the stacked/folded type electrode assembly is a combination of the a jelly-roll type electrode assembly and the stacked type electrode assembly. Among them, the jelly-roll type electrode assembly has the advantages in that that manufacture is easy and the energy density per weight is high.

In particular, in a jelly-roll type electrode assembly, the wound electrodes repeat expansion and contraction during charge and discharge cycles. Due to this repetition of expansion and contraction, stress may be concentrated in a specific portion of the electrode assembly, including the electrodes. Particularly, a tape may be attached to the end of the electrode being wound, and stress may be concentrated at the end of the tape in a charge and discharge process, which may cause cracks.

Cracks occurring in the electrodes not only deteriorate the performance of the secondary battery but also cause safety issues such as thermal runaway, and thus, there is a need to develop a technology that prevents cracks due to the attached tape.

### SUMMARY

### Technical Problem

It is an object of the present disclosure to provide an electrode assembly with a jelly roll structure that can prevent occurrence of cracks even when charge and discharge are repeated, and a secondary battery including the same.

However, the technical problems to be solved by aspects of the present disclosure are not limited to the above-described problems, and can be variously expanded within the scope of the technical idea included in the present disclosure.

### Technical Solution

According to one aspect of the present disclosure, there is provided an electrode assembly comprising: electrodes; a separator interposed between the electrodes; and at least one tape attached to at least one of the electrodes, wherein the electrodes and the separators are wound together to form a jelly roll structure, wherein the tape is attached to an area including one end of the electrode, on at least one of the two surfaces of the electrode, and wherein one side of the tape has a non-linear pattern.

A non-linear pattern may be formed on one side located away from one end of the electrode, among both opposing sides of the tape.

The non-linear pattern may be a zigzag pattern, a wave pattern, or a sawtooth pattern.

The electrode may include an electrode current collector and an electrode active material layer formed by coating an electrode active material onto the electrode current collector.

At the one end of the electrode, an electrode active material layer is not formed, and an exposed portion, which is a portion where the electrode current collector is exposed, is formed.

The tape may be attached to the electrode while covering the exposed portion and a portion of the electrode active material layer.

A balcony portion may be formed at an end in the direction of the exposed portion among the electrode active material layer.

The tape may be attached to the electrode while covering the balcony portion.

The non-linear pattern of the tape may be located on the electrode active material layer.

The one end of the electrode where the exposed portion is formed corresponds to an end at the core side of the jelly roll structure.

The tape may include a material that is electrically insulating.

The tape may include at least one of polyimide (PI) or polypropylene (PP).

According to another aspect of the present disclosure, there is provided a secondary battery comprising the electrode assembly.

### Advantageous Effects

According to aspects of the present disclosure, in the electrode assembly of the jelly roll structure, one side of the tape attached to an area including one end of the electrode may be formed in a non-linear pattern. Since one side of the tape has a non-linear pattern, stress can be prevented from concentrating on a specific portion of the electrode adjacent to one side of the tape, thereby preventing occurrence of cracks.

Effects obtainable from the present disclosure are not limited to the effects mentioned above, and additional other effects not mentioned herein will be clearly understood from the description and the appended drawings by those skilled in the art.

### BRIEF DESCRIPTION OF THE DRAWINGS

FIG. 1 is an exploded perspective view of an electrode assembly according to an aspect of the present disclosure.

FIG. 2 is a perspective view showing the state in which the electrode assembly of FIG. 1 is wound.

FIGS. 3 and 4 are respectively a front view and a plan view, enlarging and showing the state in which a tape is attached to an electrode in the electrode assembly of FIG. 1.

FIGS. 5 and 6 are plan views showing tapes according to some aspects of the present disclosure.

FIG. 7 is an exploded perspective view showing a cylindrical secondary battery according to an aspect of the present disclosure.

FIG. 8 is an exploded perspective view showing a pouch-type secondary battery according to an aspect of the present disclosure.

FIG. 9 is an exploded perspective view showing a prismatic secondary battery according to an aspect of the present disclosure.

### DETAILED DESCRIPTION

Reference characters used in the present disclosure are as follows:
100: secondary battery
200: electrode assembly
210: first electrode
211: first electrode current collector
212: first electrode active material layer
220: second electrode
221: second electrode current collector
222: second electrode active material layer
300 a, 300 b, 300c: tape
300 pa, 300 pb, 300pc: non-linear pattern

Hereinafter, various aspects of the present disclosure will be described in detail with reference to the accompanying drawings so that those skilled in the art can easily carry out them. The present disclosure may be modified in various different ways, and is not limited to the aspects set forth herein.

A description of portions that are not related to the description will be omitted for clarity, and same reference numerals designate same or like elements throughout the description.

Further, in the drawings, the size and thickness of each element are arbitrarily illustrated for convenience of description, and the present disclosure is not necessarily limited to those illustrated in the drawings. In the drawings, the thickness of layers, areas, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when it is referred to as “cross-sectional”, it means when a target portion is viewed from the side of a cross section cut vertically.

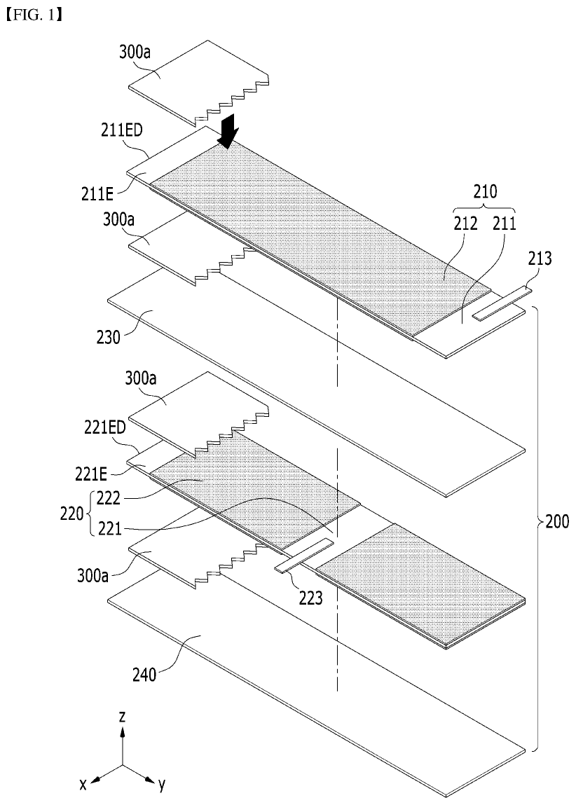

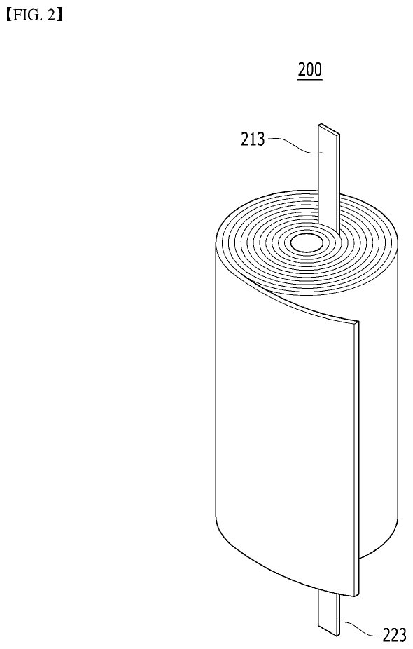

FIG. 1 is an exploded perspective view of an electrode assembly according to an aspect of the present disclosure. FIG. 2 is a perspective view showing the state in which the electrode assembly of FIG. 1 is wound.

Referring to FIGS. 1 and 2, the electrode assembly 200 according to an aspect of the present disclosure includes electrodes 210, 220; a separator 230 interposed between the electrodes 210 and 220; and at least one tape 300a attached to at least one of the electrodes 210 and 220. The electrodes 210 and 220 and the separators 230 and 240 are wound together to form a jelly roll structure. That is, the electrode assembly 200 according to the present aspect is a jelly-roll shaped electrode assembly.

The electrodes 210 and 220 may be divided into a first electrode 210 and a second electrode 220. Any one separator 230 may be interposed between the first electrode 210 and the second electrode 220. In addition, as shown in FIG. 1, when wound in a jelly roll form, in order to prevent the first electrode 210 and the second electrode 220 from coming into contact with each other, it is preferable that a separator 240 is further arranged under the second electrode 220.

The first electrode 210 includes a first electrode current collector 211 and a first electrode active material layer 212 formed by coating an electrode active material onto the first electrode current collector 211. Specifically, an electrode active material is coated onto the first electrode current collector 211 to form a first electrode active material layer 212, and a first electrode tab 213 can be attached by a method such as welding to a portion where the electrode active material is not coated and the first electrode current collector 211 is exposed among the first electrode current collector 211. Here, the first electrode tab 213 is shown as being located at one end of the first electrode 210, however, the position thereof is not particularly limited, and it is also possible to be located in the center part of the first electrode 210.

The second electrode 220 includes a second electrode current collector 221 and a second electrode active material layer 222 formed by coating an electrode active material onto the second electrode current collector 221. Specifically, an electrode active material is coated onto the second electrode current collector 221 to form a second electrode active material layer 222, and a second electrode tab 223 may be attached by a method such as welding to a portion where the electrode active material is not coated and the second electrode current collector 221 is exposed among the second electrode current collector 221. Here, the second electrode tab 223 is shown as being located in the center part of the second electrode 220, however, the position thereof is not particularly limited, and it is also possible to be located at one end of the second electrode 220.

In a state where the electrode assembly 200 is wound, the first electrode tab 213 may protrude in one direction, and the second electrode tab 223 may protrude in a direction opposite to the direction in which the first electrode tab 213 protrudes, as shown in FIG. 2.

The first electrode 210 may be a positive electrode, and the second electrode 220 may be a negative electrode. That is, the first electrode current collector 211 and the first electrode tab 213 may be a positive electrode current collector and a positive electrode tab, respectively, and the second electrode current collector 221 and the second electrode tab 223 may be a negative electrode current collector and a negative electrode tab, respectively. The first electrode current collector 211 is a positive electrode current collector, and may include at least one of stainless steel, aluminum, nickel, and titanium, wherein a positive electrode active material may be coated thereon to form a first electrode active material layer 212. The second electrode current collector 221 is a negative electrode current collector, and may include at least one of copper, stainless steel, aluminum, and nickel, wherein a negative electrode active material may be coated thereon to form a second electrode active material layer 222.

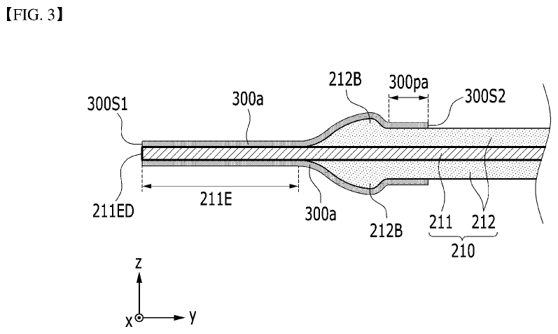

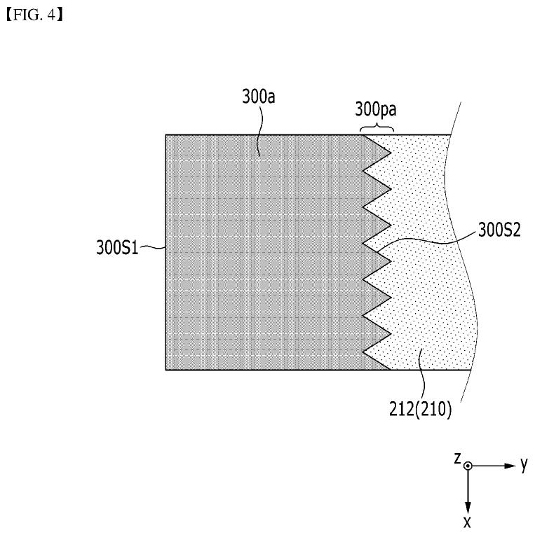

Next, the tape according to the present aspect will be described in detail with reference to FIGS. 3 and 4.

FIGS. 3 and 4 are respectively a front view and a plan view, enlarging and showing the state in which a tape is attached to an electrode in the electrode assembly of FIG. 1. Specifically, the tape 300a is shown in the state attached to the first electrode 210 among the electrodes 210 and 220. More specifically, FIG. 3 is a front view of the attached tape 300a viewed along the −x axis direction on the yz plane, and FIG. 4 is a plan view of the attached tape 300a viewed along the −z axis direction on the xy plane.

Referring to FIGS. 1, 3, and 4 together, the electrode assembly 200 according to the present aspect includes at least one tape 300a that is attached to at least one of the electrodes 210 and 220, as described above. That is, the tape 300a may be attached to any one of the electrodes 210 and 220, or may be attached to both the electrodes 210 and 220. As an example, FIG. 1 shows the state where tapes 300a are attached to both sides of each of the electrodes 210 and 220.

Hereinafter, in order to avoid duplication of explanation, the tape 300a attached to the first electrode 210 will be mainly described, however, a similar or identical structure can be applied even to the tape 300a attached to the second electrode 220.

The tape 300a according to the present aspect is attached to an area including one end 211ED of the first electrode 210, on at least one of both surfaces of the first electrode 210. In other words, the tape 300a may not be attached to the central area spaced apart from both ends of the first electrode 210, but may be attached to the area including one end 211ED. The first electrode 210 may have a rectangular sheet shape having long sides and short sides. The one end 211ED to which the tape 300a is attached may be one of the short sides of the first electrode 210.

Further, the tape 300a may be attached on the whole of both surfaces of the first electrode 210, or may be attached to only one surface. FIGS. 1 and 3 show the state where a tape 300a is attached to each of the both surfaces of the first electrode 210. Attaching on both surfaces or one surface of the electrodes 210 and 220 may vary depending on the design and manufacturing process of the corresponding electrodes 210 and 220.

If the tape 300a is also attached to the second electrode 220, the tape 300a can be similarly attached to an area including one end 221ED of the second electrode 220, on at least one of the both surfaces of the second electrode 220.

At this time, according to the present aspect, one side 300S2 of the tape 300a may have a non-linear pattern 300pa. In the present aspect, a non-linear pattern means a shape that is not a straight line, and may be a wave pattern, a zigzag pattern, or a sawtooth pattern. This will be explained again below.

Among the both opposing sides 300S1 and 300S2 of the tape 300a, a non-linear pattern 300pa may be formed on one side 300S2 located away from one end 211ED of the first electrode 210. That is, the non-linear pattern 300pa may be located on the first electrode active material layer 212 of the first electrode 210.

On the other hand, at the one end 211ED of the first electrode 210, an exposed portion 211E is formed where the first electrode active material layer 212 is not formed and the first electrode current collector 211 is exposed. That is, the first electrode 210 may have a so-called non-free edge shape. The reason for designing the non-free edge electrode is to prevent core impingement phenomena in the jelly roll electrode assembly. The core impingement phenomenon means a phenomenon in which an end at the core side of the electrode interferes with the core direction of the jelly roll electrode assembly due to volume expansion of the electrode in a charge and discharge process of the jelly roll electrode assembly. This may damage the separator and cause a short circuit between the positive electrode and the negative electrode. Particularly, in an electrode having a relatively large volume expansion, for example, an electrode to which a large amount of Si material is added, this core collision phenomenon may become more serious. In particular, in electrodes with relatively large volume expansion, for example, electrodes with a large amount of Si material added, this core impingement phenomenon may become more serious.

Since the non-free edge electrode has an exposed portion 211E, which is a portion where the electrode current collector is exposed without being coated with the electrode active material at the end of the electrode, the degree of expansion at an end on the core side of the electrode may be made relatively small. Therefore, the non-free edge electrode is more effective in preventing core impingement than a free edge electrode in which an end on the core side of the electrode is coated with an electrode active material. That is, one end 211ED of the first electrode 210 where the exposed portion 211E is formed may correspond to an end at the core side of the jelly roll structure.

The tape 300a may be attached to the first electrode 210 while covering the exposed portion 211E and a portion of the first electrode active material layer 212. Therefore, the non-linear pattern 300pa of the tape 300a according to the present aspect may be located on the first electrode active material layer 212, as shown in the figure.

More specifically, a balcony portion 212B may be formed at an end of the first electrode active material layer 212 in the direction toward the exposed portion 211E. The balcony portion 212B refers to a portion where the amount of coating locally increases at the starting point of coating when coating the electrode active material to form the first electrode active material layer 212. That is, the electrode active material can be coated temporarily in large amounts at the starting point where the electrode active material is first coated onto the first electrode current collector 211, thereby forming the balcony portion 212B. In FIG. 3, the balcony portion 212B is exaggerated for convenience of explanation.

As described above, when the first electrode 210 is a positive electrode, the balcony portion 212B formed on the positive electrode may induce lithium precipitation at the negative electrode opposite thereto. Specifically, the N/P ratio is a value obtained by dividing the capacity of the negative electrode calculated by taking into account the area and capacity per mass of the negative electrode by the capacity of the positive electrode obtained by taking into account the area and capacity per mass of the positive electrode. Generally it has a value of 1 or more. In other words, the negative electrode is manufactured to have a large capacity. For reference, if the N/P ratio is not 1, metallic lithium is likely to precipitate in a charge and discharge process, which rapidly deteriorates the safety of the battery during high-rate charging and discharging, and acts as a cause of ignition. In other words, the N/P ratio has a significant impact on the safety and capacity of the battery. By the way, since the balcony portion 212B formed on the positive electrode is a portion where a loading amount of the positive electrode active material per unit area is locally large, the N/P ratio is lowered in relation to the opposing negative electrode, which causes lithium precipitation in the negative electrode. The balcony portion 212B may be formed mainly on a non-free edge type electrode having an exposed portion 211E.

Thus, the tape 300a according to the present aspect can be attached to the first electrode 210 while covering the balcony portion 212B generated from the first electrode 210 in a non-free edge form having an exposed portion 211E. The tape 300a attached while covering the balcony portion 212B may cut off the reaction at the balcony portion 212B, thereby preventing lithium precipitation on the negative electrode.

Further, the tape 300a according to the present aspect can suppress heat generation in the exposed portion 211E to improve safety, can suppress side reactions between the electrolyte and the exposed portion 211E, and can suppress corrosion in the exposed portion 211E. That is, in addition to preventing lithium precipitation, the purpose of attaching the tape 300a is various as described above.

Similarly, the second electrode active material layer 222 is not formed at one end 221ED of the second electrode 220, and an exposed portion 221E may be formed at a portion where the second electrode current collector 221 is exposed. If the tape 300a is also attached to the second electrode 220, the tape 300a may be attached to the second electrode 220 while covering the exposed portion 221E and a portion of the second electrode active material layer 222. Further, a balcony portion may be formed on the second electrode 220, and the tape 300a may be attached to the second electrode 220 while covering the balcony portion. Even when the second electrode 220 is a negative electrode, the tape 300a may be attached, which can suppress heat generation in the exposed portion 221E, can suppress side reactions between the electrolyte and the exposed portion 221E, and can suppress corrosion in the exposed portion 221E.

The tape 300a according to the present aspect is attached to at least one of the electrodes 210 and 220 for various purposes, as described above. At this time, as described above, the electrodes 210 and 220 repeat expansion and contraction during the charge and discharge cycle. If the tape according to this aspect does not have a non-linear pattern but one side of the tape consists of a straight line like a normal tape, stress may be concentrated on one side portion of the straight tape, which may cause cracks. Furthermore, when the electrodes 210 and 220 are rolled to form a jelly roll structure, cracks may occur in the electrodes 210 and 220 because the curvature in the centripetal direction is large. Thus, the tape 300a according to the present aspect forms a non-linear pattern 300pa on one side 300S2 located on the electrodes 210 and 220, thereby capable of preventing stress from concentrating on a specific portion and dispersing stress. Thereby, the possibility of occurrence of cracks in the electrodes 210 and 220 during charge and discharge cycles can be greatly reduced.

As described above, the non-linear pattern according to the present aspects has a shape other than a straight line, and may be a wave pattern, a zigzag pattern, or a sawtooth pattern. As an example of such a non-linear pattern 300pa, a non-linear pattern 300pa in a zigzag form is shown in FIGS. 1 and 4.

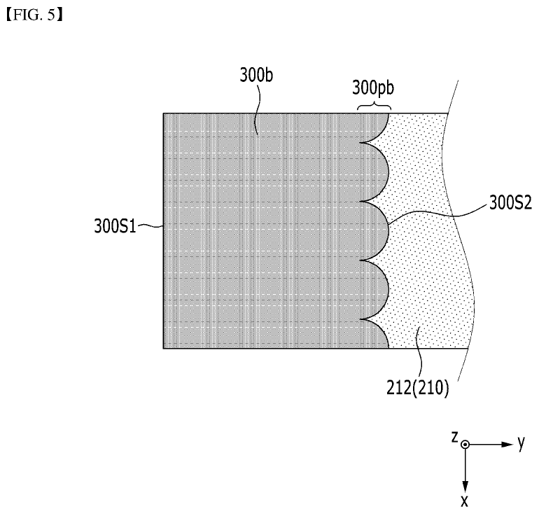

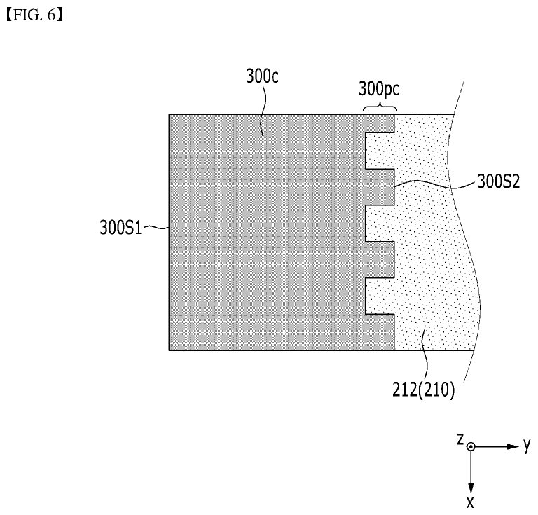

FIGS. 5 and 6 are plan views showing tapes according to some aspects of the present disclosure.

Referring to FIG. 5, among both sides 300S1 and 300S2 of the tape 300b according to another aspect of the present disclosure, a non-linear pattern 300pb in a wave form may be formed on one side 300S2 located on the first electrode active material layer 212.

Referring to FIG. 6, among both sides 300S1 and 300S2 of the tape 300c according to another aspect of the present disclosure, a non-linear pattern 300pc in a sawtooth form may be formed on one side 300S2 located on the first electrode active material layer 212.

On the other hand, the tape 300a according to the present aspect may include an electrical insulating material. As an example, the tape 300a may include at least one of polyimide (PI) or polypropylene (PP).

A secondary battery according to an aspect of the present disclosure may include the jell roll-shaped electrode assembly 200 described above. Such secondary batteries may be cylindrical batteries, pouch-shaped batteries, or prismatic batteries.

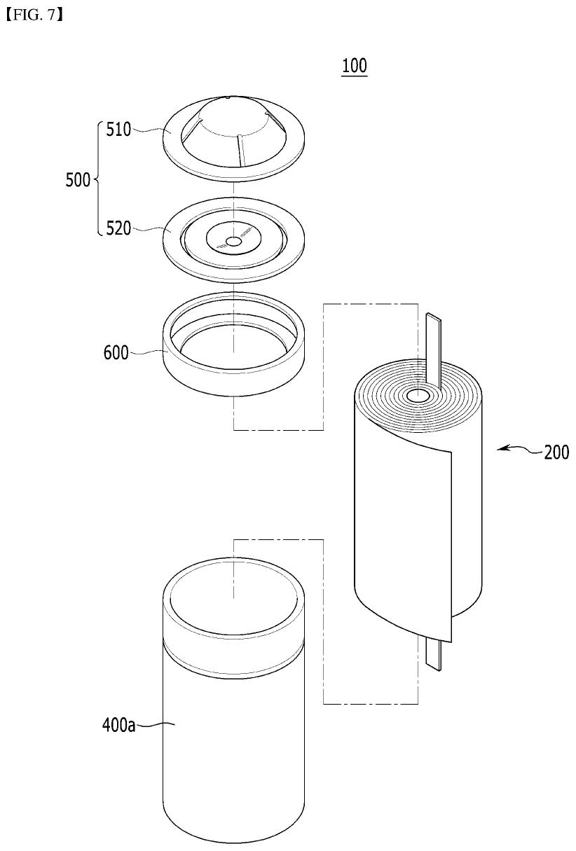

FIG. 7 is an exploded perspective view showing a cylindrical secondary battery according to an aspect of the present disclosure.

Referring to FIG. 7, the secondary battery 100 according to an aspect of the present disclosure may include a jelly roll-shaped electrode assembly 200, a cylindrical battery can 400a that has an opened upper part and houses the electrode assembly 200, and a cap assembly 500 coupled to the opened upper part of the battery can 400a. Specifically, the secondary battery 100 according to the present aspect can be manufactured by housing the electrode assembly 200 in a battery can 400a having an opened upper part, injecting an electrolyte into the battery can 400a, and then coupling the cap assembly 500.

A cap assembly 500 may include a top cap 510 and a safety vent 520. The top cap 510 is located on the safety vent 520, forms a structure in close contact with the safety vent 520, and thus can be electrically connected to the safety vent 520. The center of the top cap 510 protrudes upward, and the top cap 510 is indirectly connected to the second electrode 220 of the electrode assembly 200 through the second electrode tab 223, thereby functioning as an electrode terminal by connecting to an external circuit.

Meanwhile, a gasket 600 for sealing may be positioned between the battery can 400a and the cap assembly 500. Specifically, a gasket 600 is positioned between the battery can 400a and the cap assembly 500, and the upper end of the battery can 400a is bent, thereby capable of forming a crimp portion. Thereby, mounting of the cap assembly 500 and sealing of the secondary battery can be achieved.

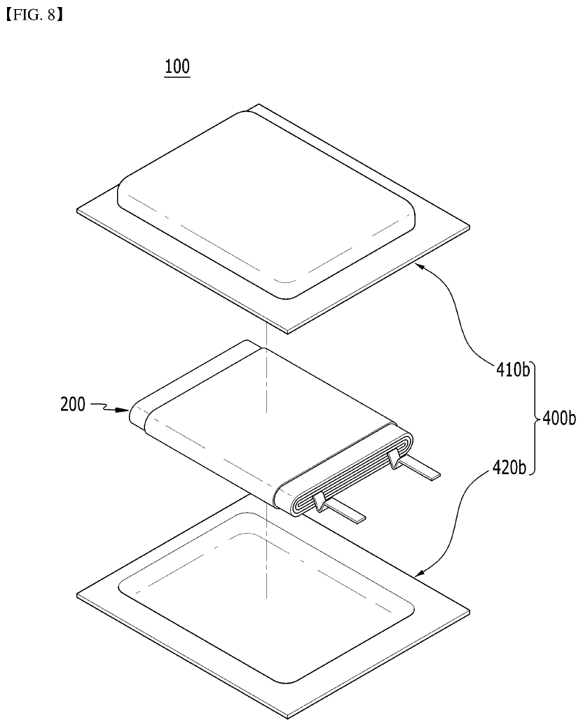

FIG. 8 is an exploded perspective view showing a pouch-type secondary battery according to an aspect of the present disclosure.

Referring to FIG. 8, the secondary battery 100 according to an aspect of the present disclosure may include a jelly roll-shaped electrode assembly 200 and a pouch-shaped case 400b that houses the electrode assembly 200. The pouch-shaped case 400b is a laminated sheet including a metal layer and a resin layer, and may include an upper case 410b and a lower case 420b.

The upper case 410b and the lower case 420b are shown as being separated from each other, however, as another aspect, a folded form is possible in which one side of the upper case 410b and one side of the lower case 420b are connected.

A housing portion in which the electrode assembly 200 is located may be formed in at least one of the upper case 410b and the lower case 420b, and heat and/or pressure is applied while the outer periphery of the upper case 410b and the outer periphery of the lower case 420b are in contact with each other, so that the outer periphery of the upper case 410b and the outer periphery of the lower case 420b can be joined to each other.

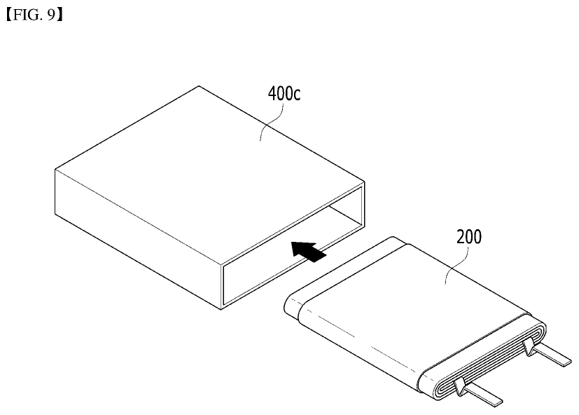

FIG. 9 is an exploded perspective view showing a prismatic secondary battery according to an aspect of the present disclosure.

Referring to FIG. 9, the secondary battery 100 according to an aspect of the present disclosure may include a jelly roll-shaped electrode assembly 200 and a prismatic can 400c that is opened on one side and houses the electrode assembly 200. Although not specifically shown in the figure, a cover member may be coupled to an opened one side of the prismatic can 400c. Welding joint may be used to join the prismatic can 400c and the cover member (not shown).

The terms representing directions such as the front side, the rear side, the left side, the right side, the upper side, and the lower side have been used in the present aspect, but the terms used are provided simply for convenience of description and may become different according to the position of an object, the position of an observer, or the like.

A plurality of the above-mentioned secondary batteries may be gathered together to form a battery module. Further, the battery modules can be mounted together with various control and protection systems such as a BMS (battery management system), and a cooling system to form a battery pack.

The secondary battery, the battery module or the battery pack can be applied to various devices. Specifically, it can be applied to vehicle means such as an electric bike, an electric vehicle, and a hybrid electric vehicle, and can be applied to various devices capable of using a secondary battery, without being limited thereto.

Although the invention has been described in detail with reference to preferred aspects thereof, the scope of the present disclosure is not limited thereto, and various modifications and improvements can be made by those skilled in the art using the basic concepts of the present disclosure, which are defined in the appended claims, which also falls within the scope of the present disclosure.

1. An electrode assembly comprising:
electrodes;
a separator interposed between the electrodes; and
tape attached to an electrode of the electrodes,
wherein the electrodes and the separators are wound together to form a jelly roll structure,
wherein the tape is attached to an area including an end of the electrode, on a surface of the electrode, and
wherein a side of the tape has a non-linear pattern.

2. The electrode assembly of claim 1, wherein:
the side of the tape having the non-linear pattern is spaced from the end of the electrode.

3. The electrode assembly of claim 1, wherein:
the non-linear pattern is a zigzag pattern, a wave pattern, or a sawtooth pattern.

4. The electrode assembly of claim 1, wherein:
the electrode includes an electrode current collector and an electrode active material layer formed by coating electrode active material onto the electrode current collector.

5. The electrode assembly of claim 4, wherein:
at the end of the electrode, an electrode active material layer is not formed, and an exposed portion of the electrode current collector is formed.

6. The electrode assembly of claim 5, wherein:
the tape covers the exposed portion of the electrode current collector and a portion of the electrode active material layer.

7. The electrode assembly of claim 5, wherein:
a balcony portion of electrode active material layer is formed at an end of the electrode active material in a direction of the exposed portion.

8. The electrode assembly of claim 7, wherein:
the tape covers the balcony portion.

9. The electrode assembly of claim 5, wherein:
the non-linear pattern is located on the electrode active material layer.

10. The electrode assembly of claim 5, wherein:
the end of the electrode where the exposed portion of the electrode current collector is formed corresponds to an end at the core side of the jelly roll structure.

11. The electrode assembly of claim 1, wherein:
the tape includes electrically insulating material.

12. The electrode assembly of claim 1, wherein:
the tape includes at least one of polyimide (PI) or polypropylene (PP).

13. A secondary battery comprising the electrode assembly according to claim 1.
